(19) United States
(12) Patent Application Publication
(10) Pub. No.: US 2008/0106611 A1
(43) Pub. Date: May 8, 2008

(54) Image signal processing circuit used in electronic product

(75) Inventors: Gang-Qiang Zheng, Shenzhen (CN); Bin Yang, Shenzhen (CN); Jian-Ying Lan, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 11/983,019

(22) Filed: Nov. 5, 2007

(30) Foreign Application Priority Data
Nov. 3, 2006 (TW) 95140734

(51) Int. Cl. H04N 5/228

(52) U.S. Cl. 348/222.1; 348/E05.031

(57) ABSTRACT

An exemplary image signal processing circuit (20) includes an image sensor (22), a drive circuit (28), and a microprocessor (24). The drive circuit includes an image signal processor (25) and a data processor (26). The microprocessor is provided to send control signals to the image sensor, the image signal processor, and the data processor. The image sensor is provided to receive exterior light beams and to convert the light beams into image signals. The image signal processor is provided to turn on the image sensor and convert the image signals received from the image sensor into image signals of a predetermined type and having a predetermined resolution. The data processor is provided to receive the image signals converted by the image signal processor and to process the converted image signals to be applied to a display device such that the display device displays corresponding images.

### FIELD OF THE INVENTION

The present invention relates to image signal processing circuits, and more particularly to an image signal processing circuit used in electronic products that have an image capturing feature.

### GENERAL BACKGROUND

Electronic products, such as mobile phones, notebooks, personal digital assistants (PDAs), and the like, are been widely used in modern daily life. Many of these electronic products have the function of taking a picture. Such electronic products usually include an image sensor, a display device, and an image signal processing circuit. Since these electronic products are typically portable, they also often miniaturized. Thus the image signal processing circuit of such electronic products is required to be compact and slim.

FIG. 3 is a schematic, block diagram of a conventional image signal processing circuit of an electronic product. The image signal processing circuit 10 includes an image sensor 12, a drive circuit 13, a microprocessor 14, and a digital signal processor (DSP) 16. The digital signal processor 16 is coupled to the image sensor 12, the drive circuit 13, and the microprocessor 14 respectively. The microprocessor 14 is coupled to the image sensor 12 and the drive circuit 13, respectively.

When a user uses the electronic products to take a picture, the microprocessor 14 sends signals to initialize the image sensor 12, the digital signal processor 16, and the drive circuit 13. Then the image sensor 12 receives exterior light beams and converts the light beams into YUV image signals. The YUV image signals are transmitted to the digital signal processor 16, and are converted into RGB (Red, Green, Blue) image signals in the digital signal processor 16. Subsequently, the RGB image signals are transmitted to the drive circuit 13. The drive circuit 13 uses the RGB image signals to drive a display device to display images. The display device can for example be a liquid crystal panel (not labeled) of a liquid crystal display (not shown).

The YUV image signals generated by the image sensor 12 cannot be recognized by the drive circuit 13 directly. Thus the digital signal processor 16 is needed for converting the YUV image signals to RGB image signals. Typically, a volume of the digital signal processor 16 is much larger than that of the other electrical elements such as the drive circuit 13. That is, the digital signal processor 16 takes up an unduly large space in the electronic product. Furthermore, the image signal processing circuit 10 needs auxiliary elements, such as power supply (not shown) to enable the digital signal processor 16 to function. The auxiliary elements also take up space in the electronic product. These disadvantages make it difficult to miniaturize the electronic product.

What is needed, therefore, is an image signal processing circuit that can overcome the above-described deficiencies.

### SUMMARY

In one aspect, an image signal processing circuit includes an image sensor, a drive circuit, and a microprocessor. The drive circuit includes an image signal processor and a data processor. The microprocessor is provided to send control signals to the image sensor, the image signal processor, and the data processor. The image sensor is provided to receive exterior light beams and to convert the light beams into image signals. The image signal processor is provided to turn on the image sensor and convert the image signals received from the image sensor into image signals of a predetermined type and having a predetermined resolution. The data processor is provided to receive the image signals converted by the image signal processor and to process the converted image signals to be applied to a display device such that the display device displays corresponding images.

In another aspect, an image signal processing circuit includes an image sensor, a data processor, an image signal processor, and a microprocessor. The image signal processor and the data processor are integrated in a drive circuit. The image signal processor is coupled to the image sensor and the data processor respectively. The microprocessor is coupled to the image sensor, the data processor, and the image signal processor respectively. The microprocessor sends control signals to the image sensor, the image signal processor, and the data processor respectively. The image signal processor receives the control signal and turns on the image sensor. Then the image sensor receives exterior light beams and converts the light beams into image signals. The image signal processor converts the image signals received from the image sensor into image signals of a particular type and having a particular resolution. The data processor receives the image signals converted by the image signal processor and process the converted image signals to be applied to a display device such that the display device displays corresponding images.

Other novel features and advantages will become more apparent from the following detailed description when taken in conjunction with the accompanying drawings.

### BRIEF DESCRIPTION OF THE DRAWINGS

FIG. 1 is a block diagram of an image signal processing circuit according to an exemplary embodiment of the present invention, together with a liquid crystal panel, the image signal processing circuit including a microprocessor and an image signal processor.

FIG. 2 is similar to FIG. 1, but not showing the microprocessor, and showing details of the image signal processor.

FIG. 3 is a block diagram of a conventional image signal processing circuit, together with a liquid crystal panel.

### DETAILED DESCRIPTION OF PREFERRED EMBODIMENTS

Reference will now be made to the drawings to describe preferred and exemplary embodiments in detail.

FIG. 1 is a block diagram showing an image signal processing circuit according to an exemplary embodiment of the present invention. The image signal processing circuit is typically installed in an electronic product. The image signal processing circuit 20 includes an image sensor 22, a microprocessor 24, and a drive circuit 28. The drive circuit 28 includes an image signal processor 25 and a data processor 26. The image sensor 22, the image signal processor 25, and the data processor 26 are electrically connected in series. The microprocessor 24 is coupled to the image sensor 22, the image signal processor 25, and the data processor 26 respectively.

The microprocessor 24 is provided to send control signals to the image sensor 22, the image signal processor 25, and the data processor 26. The image sensor 22 is provided to receive exterior light beams and convert the light beams into image signals. The image signal processor 25 is provided to turn on the image sensor 22, convert the image signals received from the image sensor 22 into image signals of a certain type and having a certain resolution, and store the converted image signals. The data processor 26 is provided to process the image signals converted by the image signal processor 25, and to enable a liquid crystal panel (not labeled) to display images according to the image signals processed by the data processor 26.

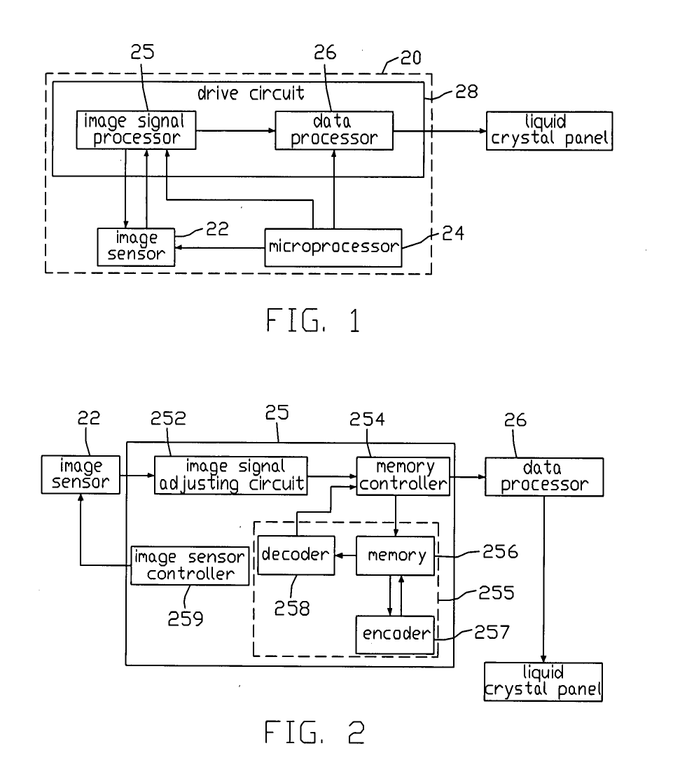

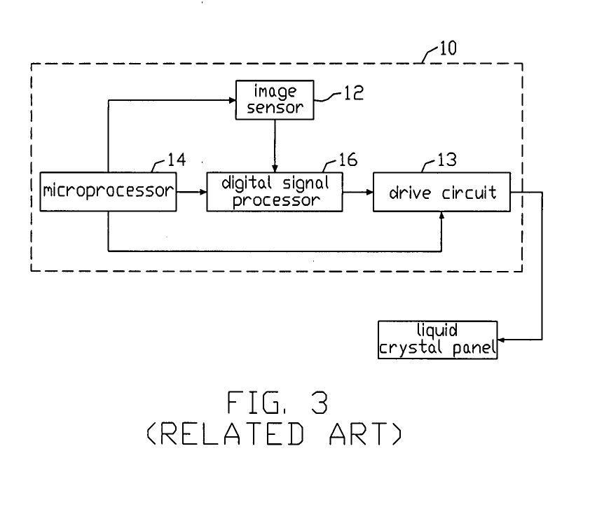

FIG. 2 is a block diagram showing details of the image signal processor 25. The image signal processor 25 includes an image signal adjusting circuit 252, a memory controller 254, a storage circuit 255, and an image sensor controller 259. The storage circuit 255 includes a memory 256, an encoder 257, and a decoder 258. The memory 256 may be a random access memory (RAM).

The image sensor controller 259 is coupled to the image sensor 22. The image sensor 22 is coupled to the memory controller 254 via the image signal adjusting circuit 252. The memory 256 is coupled to the memory controller 254, the encoder 257, and the decoder 258, respectively. The decoder 258 is coupled to the memory controller 254. The image sensor controller 259 is provided to turn on the image sensor 22. The image signal adjusting circuit 252 is provided to convert the image signals received from the image sensor 22 into image signals of a certain type and having a certain resolution. The memory controller 254 is provided to control whether the image signals received from the image signal adjusting circuit 252 are stored in the storage circuit 255.

When a user uses the electronic product to take a picture, the microprocessor 24 sends signals to initialize the image sensor 22, the image signal processor 25, and the data processor 26. The initializing signals determine whether the image signals converted by the image signal adjusting circuit 252 are stored in the storage circuit 255.

If the initializing signals instruct that the image signals converted by the image signal adjusting circuit 252 are not to be stored in the storage circuit 255, the image sensor controller 259 sends a control signal to turn on the image sensor 22. Then the image sensor 22 receives exterior light beams, and converts the light signals into YUV image signals. The resolution of images corresponding to the YUV image signals may for example be 800*600 pixels. The YUV image signals generated by the image sensor 22 are transmitted to the image signal adjusting circuit 252, and are converted into RGB image signals in the image signal adjusting circuit 252. The resolution of images corresponding to the RGB image signals may for example be 240*320 pixels. The RGB image signals are transmitted to the data processor 26 via the memory controller 254. The data processor 26 processes the RGB image signals converted by the image signal adjusting circuit 252, and enables a display device to display images according to the processed RGB image signals. The display device can for example be a liquid crystal panel (not labeled) of a liquid crystal display (not shown).

If the initializing signals instruct that the image signals converted by the image signal adjusting circuit 252 are to be stored in the storage circuit 255, the image sensor controller 259 sends a control signal to turn on the image sensor 22. The image sensor 22 receives light beams, and sends corresponding YUV image signals to the image signal adjusting circuit 25. In the image signal adjusting circuit 25, the YUV image signals are converted into RGB image signals. Then the memory controller 254 transmits the RGB image signals to the encoder 257 via the memory 256. The RGB image signals are encoded in the encoder 257, and then the encoded RGB image signals are stored in the memory 256.

When the user needs to display images according to the RGB image signals stored in the memory 256, the decoder 258 reads the encoded RGB image signals in the memory 256, and decodes the RGB image signals therein. Then the decoded RGB image signals are transmitted to the data processor 26 via the memory controller 254. The data processor 26 processes the RGB image signals transmitted from the decoder 258, and enables the liquid crystal panel to display images according to the processed RGB image signals.

In summary, the image sensor controller 259 is provided to turn on the image sensor 22, and the image signal adjusting circuit 252 is provided to convert the YUV image signals received from the image sensor 22 into RGB image signals. Therefore, the image signal processor 25 functions as a digital signal processor. That is, the image signal processor 25 is used as the equivalent of the conventional combination of a standard digital signal processor and auxiliary elements that enable the standard digital signal processor to function. The image signal processor 25 has a relatively simple configuration, which correspondingly simplifies the configuration of the image signal processing circuit 20. In addition, the image signal processor 25 and the data processor 26 are integrated in the drive circuit 28. This also reduces the volume of the image signal processing circuit 20. As a result, the electronic product that employs the image signal processing circuit 20 can be miniaturized.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An image signal processing circuit, comprising:
an image sensor configured for receiving exterior light beams and converting the light beams into image signals;
a drive circuit comprising:
an image signal processor configured for turning on the image sensor and converting the image signals received from the image sensor into image signals of a predetermined type and having a predetermined resolution; and
a data processor configured for receiving the image signals converted by the image signal processor and processing the converted image signals to enable the converted image signals to be applied to a display device such that the display device displays corresponding images; and
a microprocessor configured for sending control signals to the image sensor, the image signal processor, and the data processor.

2. The image signal processing circuit as claimed in claim 1, wherein the image signal processor comprises an image sensor controller configured for turning on the image sensor, and an image signal adjusting circuit configured for converting the image signals received from the image sensor into image signals of the predetermined type and resolution.

3. The image signal processing circuit as claimed in claim 2, wherein the image signal processor further comprises a storage circuit configured for storing image signals converted by the image signal adjusting circuit, and a memory controller configured for controlling whether the image signals converted by the image signal adjusting circuit is stored in the storage circuit, according to control signals from the microprocessor.

4. The image signal processing circuit as claimed in claim 3, wherein the storage circuit comprises a memory.

5. The image signal processing circuit as claimed in claim 4, wherein the memory comprises a random access memory.

6. The image signal processing circuit as claimed in claim 4, wherein the storage circuit further comprises an encoder configured for encoding image signals that stored in the memory, and a decoder configured for decoding encoded image signals that stored in the memory.

7. The image signal processing circuit as claimed in claim 1, wherein the image sensor converts light signals into YUV image signals.

8. The image signal processing circuit as claimed in claim 7, wherein the image signal processor converts the YUV image signals into RGB image signals.

9. The image signal processing circuit as claimed in claim 7, wherein a resolution of images corresponding to the YUV image signals is 800*600 pixels.

10. The image signal processing circuit as claimed in claim 8, wherein a resolution of images corresponding to the RGB image signals is 240*320 pixels.

11. The image signal processing circuit as claimed in claim 1, wherein the data processor is configured to apply the converted image signals to the display device such that the display device displays the corresponding images.

12. The image signal processing circuit as claimed in claim 11, wherein the display device comprises a liquid crystal panel.

13. An image signal processing circuit, comprising:
an image sensor;
a data processor;
an image signal processor coupled to the image sensor and the data processor respectively; and
a microprocessor coupled to the image sensor, the data processor, and the image signal processor respectively;
wherein the image signal processor and the data processor are integrated in a drive circuit, the microprocessor sends control signals to the image sensor, the image signal processor, and the data processor respectively, the image signal processor receives the control signal and turns on the image sensor, the image sensor receives exterior light beams and converts the light beams into image signals, the image signal processor receives the image signals from the image sensor and converts the image signals into image signals of a particular type and having a particular resolution, and the data processor receives the image signals converted by the image signal processor and processes the converted image signals to enable the converted image signals to be applied to a display device such that the display device, displays corresponding images.

14. The image signal processing circuit as claimed in claim 13, wherein the image signal processor comprises an image sensor controller configured for turning on the image sensor, and an image signal adjusting circuit configured for converting the image signals received from the image sensor into image signals with particular type and resolution.

15. The image signal processing circuit as claimed in claim 14, wherein the image signal processor further comprises a storage circuit configured for storing image signals converted by the image signal adjusting circuit, and a memory controller configured for controlling whether the image signals converted by the image signal adjusting circuit is stored in the storage circuit, according to control signals from the microprocessor.

16. The image signal processing circuit as claimed in claim 15, wherein the storage circuit comprises a memory.

17. The image signal processing circuit as claimed in claim 16, wherein the memory comprises a random access memory.

18. The image signal processing circuit as claimed in claim 16, wherein the storage circuit further comprises an encoder configured for encoding image signals that stored in the memory, and a decoder configured for decoding encoded image signals that are stored in the memory.
